(19) United States
(12) Patent Application Publication
(10) Pub. No.: US 2026/0010386 A1
(43) Pub. Date: Jan. 8, 2026

(54) CROSS-PLATFORM DATA PROCESSING

(71) Applicant: TENCENT TECHNOLOGY (SHENZHEN) COMPANY LIMITED, Shenzhen (CN)

(72) Inventors: Chen HE, Shenzhen (CN); Wei LI, Shenzhen (CN); He WEN, Shenzhen (CN); Jiale CHEN, Shenzhen (CN); Jingyu LU, Shenzhen (CN); Fenglian WEI, Shenzhen (CN)

(73) Assignee: TENCENT TECHNOLOGY (SHENZHEN) COMPANY LIMITED, Shenzhen (CN)

(21) Appl. No.: 19/328,795

(22) Filed: Sep. 15, 2025

Related U.S. Application Data
(63) Continuation of application No. PCT/CN2024/100042, filed on Jun. 19, 2024.

(30) Foreign Application Priority Data
Jun. 26, 2023 (CN) 202310762989.9

(51) Int. Cl. G06F 9/451; G06F 9/448

(52) U.S. Cl. CPC G06F 9/451; G06F 9/4484

(57) ABSTRACT

In a data processing method, a first service control element in a first subprogram in a second application is output for display based on a determination that a first service operation initiated by a user satisfies a display condition. The first service operation is initiated in a first application or in the first subprogram embedded in the second application. The first service operation is executed through a service function provided by the second application. The first service control element is provided by the second application. The first subprogram corresponds to the first application. A service platform corresponding to the first application is different from a service platform corresponding to the second application. A first service message in the first service control element is output for display. The first service message is provided by the second application and is associated with the first service operation.

### RELATED APPLICATIONS

The present application is a continuation of International Application No. PCT/CN2024/100042, filed on Jun. 19, 2024, which claims priority to Chinese Patent Application No. 202310762989.9, filed on Jun. 26, 2023. The entire disclosures of the prior applications are hereby incorporated by reference.

### FIELD OF THE TECHNOLOGY

This application relates to the field of Internet technologies, including a data processing method.

### BACKGROUND OF THE DISCLOSURE

With the development of Internet technologies, various application programs emerge one after another. To reduce occupation of an internal memory of a terminal device and development costs and popularization costs of an application program, a subroutine (for example, a mini program) in the application program rapidly develops.

The mini program has a relatively low development threshold, can satisfy a requirement for a simple basic application, and is suitable for an offline life service store and conversion of a non-rigid-demand low-frequency application. Time costs and an internal memory space of a mobile phone can be saved for a user. Development and popularization costs can also be reduced for a developer.

### SUMMARY

Aspects of this disclosure provide a data processing method, a data processing apparatus, and a non-transitory computer-readable storage medium, to not only improve a presentation effect of a first subroutine, but also improve display efficiency of a first service message.

An aspect of this disclosure provides a data processing method. In the method, a first service control element in a first subprogram in a second application is output for display based on a determination that a first service operation initiated by a user satisfies a display condition. The first service operation is initiated in a first application or in the first subprogram embedded in the second application. The first service operation is executed through a service function provided by the second application. The first service control element is provided by the second application. The first subprogram corresponds to the first application. A service platform corresponding to the first application is different from a service platform corresponding to the second application. A first service message in the first service control element is output for display. The first service message is provided by the second application and is associated with the first service operation.

An aspect of this disclosure provides a data processing apparatus. The apparatus includes processing circuitry configured to output for display a first service control element in a first subprogram in a second application based on a determination that a first service operation initiated by a user satisfies a display condition. The first service operation is initiated in a first application or in the first subprogram embedded in the second application. The first service operation is executed through a service function provided by the second application. The first service control element is provided by the second application. The first subprogram corresponds to the first application. A service platform corresponding to the first application is different from a service platform corresponding to the second application. The processing circuitry is configured to output for display a first service message in the first service control element. The first service message is provided by the second application and is associated with the first service operation.

An aspect of this disclosure provides a data processing method, including: displaying, in response to that a first service operation performed by a service object in a first application or a first subroutine embedded in a second application meets a control presentation condition, a first service control in the first subroutine in the second application, the first service operation being implemented through a service function provided by the second application; the first service control being provided by the second application; the first subroutine being a subroutine corresponding to the first application, and a service platform corresponding to the first application being the different from a service platform corresponding to the second application; and displaying a first service message in the first service control, the first service message being provided by the second application, and the first service message being associated with the first service operation.

An aspect of this disclosure further provides a data processing apparatus, including: a first display module, configured to display, in response to that a first service operation performed by a service object in a first application or a first subroutine embedded in a second application meets a control presentation condition, a first service control in the first subroutine in the second application, the first service operation being implemented through a service function provided by the second application; the first service control being provided by the second application; the first subroutine being a subroutine corresponding to the first application, and a service platform corresponding to the first application being different from a service platform corresponding to the second application; and a second display module, configured to display a first service message in the first service control, the first service message being provided by the second application, and the first service message being associated with the first service operation.

An aspect of this disclosure further provides a computer device, including: a processor, a memory, and a network interface, the processor being connected to the memory and the network interface, the network interface being configured to provide a data communication function, the memory being configured to store a computer program, and the processor being configured to invoke the computer program, to cause the computer device to perform the methods according to the aspects of this disclosure.

An aspect of this disclosure provides a non-transitory computer-readable storage medium, having computer-executable instructions stored therein, the computer-executable instructions, when executed by a processor, cause the processor to implement the methods according to the aspects of this disclosure.

An aspect of this disclosure further provides a computer program product, the computer program product including a computer program, and the computer program being stored in a computer-readable storage medium; a processor of a computer device reading the computer program from the computer-readable storage medium, and the processor executing the computer program, to cause the computer device to perform the methods according to the aspects of this disclosure.

### BRIEF DESCRIPTION OF THE DRAWINGS

FIG. 1 is a schematic diagram of an architecture of a system according to an aspect of this disclosure.

FIG. 2 is a schematic diagram of a data processing scenario according to an aspect of this disclosure.

FIG. 3 is a schematic diagram of another data processing scenario according to an aspect of this disclosure.

FIG. 4 is a schematic flowchart of a data processing method according to an aspect of this disclosure.

FIG. 5 is a schematic diagram of another data processing scenario according to an aspect of this disclosure.

FIG. 6 is a schematic diagram of another data processing scenario according to an aspect of this disclosure.

FIG. 7 is a schematic flowchart of another data processing method according to an aspect of this disclosure.

FIG. 8 is a schematic diagram of another data processing scenario according to an aspect of this disclosure.

FIG. 9 is a schematic diagram of another data processing scenario according to an aspect of this disclosure.

FIG. 10 is a schematic flowchart of another data processing method according to an aspect of this disclosure.

FIG. 11 is a schematic structural diagram of a data processing apparatus according to an aspect of this disclosure.

FIG. 12 is a schematic structural diagram of a computer device according to an aspect of this disclosure.

### DETAILED DESCRIPTION

To make the objectives, technical solutions, and advantages of this disclosure clearer, the following describes this disclosure in further detail with reference to the accompanying drawings. The descriptions of the terms are provided as examples only and are not intended to limit the scope of the disclosure.

The technical solutions in aspects of this disclosure are described in the following with reference to the accompanying drawings. The described aspects are merely some rather than all of the aspects of this disclosure. Other aspects shall fall within the scope of this disclosure.

In some implementation methods, a first application may access a service function provided by a second application. Therefore, a service object may perform, in the first application that accesses the second application or in a subroutine corresponding to the first application, a service operation associated with the service function. The subroutine corresponding to the first application may be in the second application. The subroutine that corresponds to the first application and that is in the second application may display a fixed-function control associated with the service function. As service functions provided by the second application are continuously accessed, fixed-function controls are continuously added to the subroutine corresponding to the first application. This reduces a presentation effect of the subroutine corresponding to the first application. In addition, the fixed-function controls have only a function of jumping to a service page configured for displaying a service message. That is, if the service object triggers no fixed-function control, no service message is displayed, thereby reducing service message display efficiency.

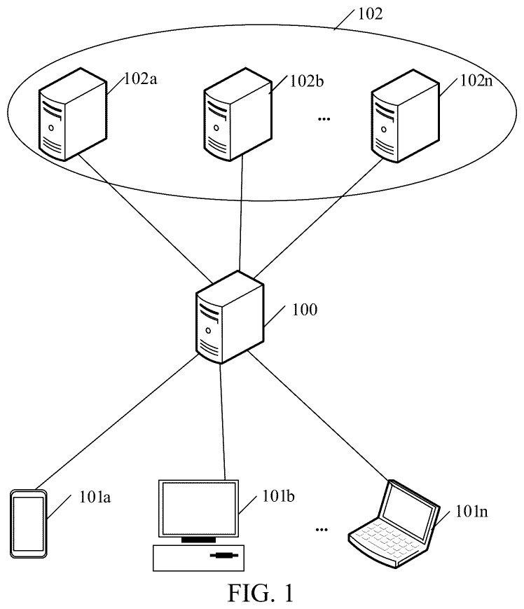

FIG. 1 is a schematic diagram of an architecture of a system according to an aspect of this disclosure. As shown in FIG. 1, the system may include a service server 100, a service server cluster 102, and a terminal device cluster. The terminal device cluster may include one or more terminal devices, and a quantity of terminal devices is not limited in this disclosure. As shown in FIG. 1, the terminal device cluster may include: a terminal device 101a, a terminal device 101b, . . . , and a terminal device 101n. Each terminal device in the terminal device cluster may include: a smart terminal with a digital resource transfer function, such as a smartphone, a tablet computer, a notebook computer, a desktop computer, a smart speaker, a smartwatch, an on-board terminal, and a smart television.

A plurality of application clients may be installed on each terminal device in the terminal device cluster shown in FIG. 1. The plurality of application clients include an independent client and embedded subclients integrated in the independent client. In the aspect of this disclosure, the independent client is referred to as a second application. When the second application runs in the terminal devices, data interaction may be separately performed with the service server 100 shown in FIG. 1. The second application may be an application client with an embedded subroutine function such as a video application, a convenient-life application, a payment application, a financial management application, a game application, a shopping application, a novel application, and a browser. The subroutine in the aspect of this disclosure includes, but is not limited to, a first subroutine and a second subroutine. Any subroutine in this disclosure is an embedded subclient, for example, a mini program.

A service platform corresponding to the first subroutine is the same as a service platform corresponding to the first application. The first application in the aspect of this disclosure may include a first subroutine developed by a service platform (for example, a service platform a) and embedded in the second application. In addition, the first application may further include an independent client.

A service platform corresponding to the second subroutine is the same as a service platform corresponding to a third application, and the service platform corresponding to the second subroutine is different from the service platform corresponding to the first subroutine. The third application in the aspect of this disclosure may include a second subroutine developed by another service platform (for example, a service platform b) and embedded in the second application. In addition, the third application may further include an independent client.

The service server 100 in the aspect of this disclosure may be a server corresponding to the second application. With an example in which the second application is a payment application, the service server 100 may be a set of a plurality of servers including a backend server, a data processing server, and the like corresponding to the payment application. Therefore, each terminal device may transmit data to the service server 100 through an application client corresponding to the payment application. For example, each terminal device may upload a locally generated second service message to the service server 100 through an application client of the payment application, and the service server 100 may forward the second service message to a service server corresponding to the first application, for example, a service server 102a in the service server cluster 102 shown in FIG. 1, or the service server 100 uploads the second service message to a cloud server. In some aspects, the terminal device may directly transmit the second service message to the service server 102a in a peer-to-peer (P2P) manner. The service server 100 may be an independent physical server, or may be a server cluster or distributed system including a plurality of physical servers, or may be a cloud server that provides a cloud computing service.

The service server cluster 102 may include one or more service servers, and a quantity of the service servers is not limited in this disclosure. As shown in FIG. 1, the service server cluster 102 may include: a service server 102a, a service server 102b, . . . , and a service server 102n. Each service server in the service server cluster 102 may be a server corresponding to a service platform providing a subroutine function. For example, the service server 102a is a server corresponding to a first service platform providing the first subroutine, the service server 102b is a server corresponding to a second service platform providing the second subroutine, and the service server 102n is a server corresponding to a third service platform providing a third subroutine. The first service platform, the second service platform, and the third service platform are independent service platforms, and are all different from a service platform corresponding to the second application. Each service server in the service server cluster 102 may be an independent physical server, or may be a server cluster or distributed system including a plurality of physical servers, or may be a cloud server that provides a cloud computing service.

Communication connections may exist between the terminal device clusters. For example, a communication connection exists between the terminal device 101a and the terminal device 101b, and a communication connection exists between the terminal device 101a and the terminal device 101n. In addition, any terminal device in the terminal device cluster may be in communication connection with the service server 100. For example, a communication connection exists between the terminal device 101a and the service server 100. In addition, any terminal device in the terminal device cluster may be in communication connection with any service server in the service server cluster 102. For example, a communication connection exists between the terminal device 101a and the service server cluster 102. In addition, any service server in the service server cluster 102 may be in communication connection with the service server 100. A connection manner of the communication connection is not limited. A direct or indirect connection may be performed in a wired communication manner or a wireless communication manner or in another manner. This is not limited in this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

For case of subsequent understanding and description, in the aspect of this disclosure, one terminal device may be selected from the terminal device cluster shown in FIG. 1 for an example. For example, the terminal device 101a is used as an example. There is a binding relationship between the service object and the terminal device 101a, and the service object is an object that operates the terminal device 101a. The second application is installed on the terminal device 101a. The first subroutine may be embedded in the second application. The first subroutine is an application client such as a short video application, a video application, a live streaming application, a game application, a music application, a shopping application, a novel application, or a browser, which is different from the second application (the same is true for the first application).

The service object performs a first service operation in the first application (for example, the first subroutine and an independent client) installed on the terminal device 101a. Because the first service operation is implemented by the service function provided by the second application, the service server corresponding to the second application, for example, the service server 100 shown in FIG. 1, may determine the first service operation, that is, determine whether the first service operation meets a control presentation condition. If the first service operation meets the control presentation condition, the service server 100 may deliver a first service control to the service server corresponding to a first application, for example, the service server 102a shown in FIG. 1, and the service server 102a delivers the first service control to the first subroutine on the terminal device 101a. Therefore, the terminal device 101a may display the first service control in the first subroutine in the second application. The service platform corresponding to the first application is the same as the service platform corresponding to the first subroutine. The first application includes, but is not limited to, a subroutine provided by a service platform, namely, the first subroutine.

In some aspects, the service server 100 may deliver the first service control to the first subroutine on the terminal device 101a in a P2P manner. Therefore, the terminal device 101a may display the first service control in the first subroutine in the second application. In some aspects, the service server 100 may transmit, to the terminal device 101a, an operation success message configured for indicating that the first service operation meets the control presentation condition. Therefore, the terminal device 101a may display the locally stored first service control in the first subroutine in the second application. The first service control stored in the terminal device 101a is provided by the service server 100.

Another implementation is as follows. The service object performs a first service operation in the first application installed on the terminal device 101a, and the service server corresponding to the first application, for example, the service server 102a shown in FIG. 1, may determine the first service operation, that is, determine whether the first service operation meets a control presentation condition. If the first service operation meets the control presentation condition, the service server 102a may deliver the first service control to the first subroutine on the terminal device 101a. Therefore, the terminal device 101a may display the first service control in the first subroutine in the second application. The first service control is provided to the service server 102a by the service server 100 corresponding to the second application. In some aspects, the service server 102a may transmit, to the terminal device 101a, an operation success message configured for indicating that the first service operation meets the control presentation condition. Therefore, the terminal device 101a may display the locally stored first service control in the first subroutine in the second application. The first service control stored in the terminal device 101a is provided by the service server 100.

Another implementation is as follows. The service object performs a first service operation in the first application installed on the terminal device 101a, and the terminal device 101a locally determines the first service operation, that is, determines whether the first service operation meets a control presentation condition. The terminal device 101a displays the first service control in the first subroutine in the second application if the first service operation meets the control presentation condition. The first service control stored in the terminal device 101a is provided by the service server 100.

Another implementation is as follows. The service object performs a first service operation in the first subroutine embedded in the second application. Because the first service operation is implemented by the service function provided by the second application, the service server corresponding to the second application, for example, the service server 100 shown in FIG. 1, may determine the first service operation, that is, determine whether the first service operation meets a control presentation condition. If the first service operation meets the control presentation condition, the service server 100 may deliver a first service control to the service server corresponding to the first application, for example, the service server 102a shown in FIG. 1, and the service server 102a delivers the first service control to the first subroutine on the terminal device 101a. Therefore, the terminal device 101a may display the first service control in the first subroutine in the second application. The first subroutine is a subroutine corresponding to the first application. The service platform corresponding to the first application is the same as the service platform corresponding to the first subroutine, and the service platform corresponding to the first application is different from the service platform corresponding to the second application.

The second application is not limited in the aspect of this disclosure. Therefore, the service function provided by the second application is not limited, the first service operation implemented through the service function is not limited, and the first service control is not limited. For example, the second application is a transaction application, and the first application and the first subroutine each are a convenient-life application. A service function provided by the second application for the first application may be a transaction payment function. The first service operation may be a transaction payment operation, and the first service control may be a transaction evaluation control. For another example, the second application is a transaction application, and the first application and the first subroutine each are a game application. A service function provided by the second application for the first application may be an account login function, that is, the first application is logged in to through an application account of the service object in the second application. The first service operation may be an account login operation, and the first service control may be an account state query control.

Further, the terminal device 101a may display a first service message in the first service control, where the first service message is provided by the second application, and the first service message is associated with the first service operation. Similarly, the second application is not limited in the aspect of this disclosure, and therefore, the first service message provided by the second application is not limited. For example, the second application is a transaction application, and the first application and the first subroutine each are a convenient-life application. The first service message provided by the second application may be a transaction evaluation prompt message. For another example, the second application is a transaction application, and the first application and the first subroutine each are a game application. The first service message provided by the second application may be an account login abnormality prompt message.

The service server 100, the terminal device 101a, the terminal device 101b, the terminal device 101n, the service server 102a, the service server 102b, and the service server 102n may all be blockchain nodes in a blockchain network. Data (for example, the service prompt message and the second service message) described throughout the specification may be stored in a manner that the blockchain nodes generate blocks according to the data and add the blocks to a blockchain for storage.

The blockchain is a novel application mode of computer technologies such as distributed data storage, point-to-point transmission, a consensus mechanism, and an encryption algorithm, and is mainly configured to sort data in chronological order and encrypt the data into a ledger so that the data cannot be tampered with or forged and the data can be verified, stored, and updated. The blockchain is essentially a decentralized database. Each node in the database stores an identical blockchain. A blockchain network can classify nodes into core nodes, data nodes, and light nodes. The core nodes, the data nodes, and the light nodes jointly form blockchain nodes. The core nodes are responsible for a consensus of the entire blockchain network. That is, the core nodes are consensus nodes in the blockchain network. A process in which transaction data in the blockchain network is written to a ledger may be as follows. Data nodes or light nodes in the blockchain network obtain the transaction data, and transmit the transaction data in the blockchain network (that is, the nodes transmit the transaction data in a baton manner) until consensus nodes receive the transaction data. The consensus nodes package the transaction data into a block, perform a consensus on the block, and write the transaction data to the ledger after the consensus is completed. Herein, the transaction data, for example, includes the service prompt message and the second service message. After performing a consensus on the transaction data, the service server 100 (blockchain node) generates a block according to the transaction data, and stores the block in the blockchain network. For reading of the transaction data (namely the service prompt message and the second service message), the block including the transaction data may be obtained by the blockchain node in the blockchain network, and further, the transaction data is obtained from the block.

The method according to the aspect of this disclosure may be performed by a computer device. The computer device includes, but is not limited to, a terminal device or a service server. The service server may be an independent physical server, or may be a server cluster or distributed system including a plurality of physical servers, or may be a cloud server providing basic cloud computing services such as a cloud database, a cloud service, cloud computing, a cloud function, cloud storage, a network service, cloud communication, a middleware service, a domain name service, a security service, a content delivery network (CDN), big data, and an artificial intelligence platform. The terminal device includes, but is not limited to, a mobile phone, a computer, an intelligent voice interaction device, an intelligent household appliance, an on-board terminal, an aircraft, and the like. The terminal device may be directly or indirectly connected to the service server in a wired or wireless manner. This is not limited in the aspect of this disclosure.

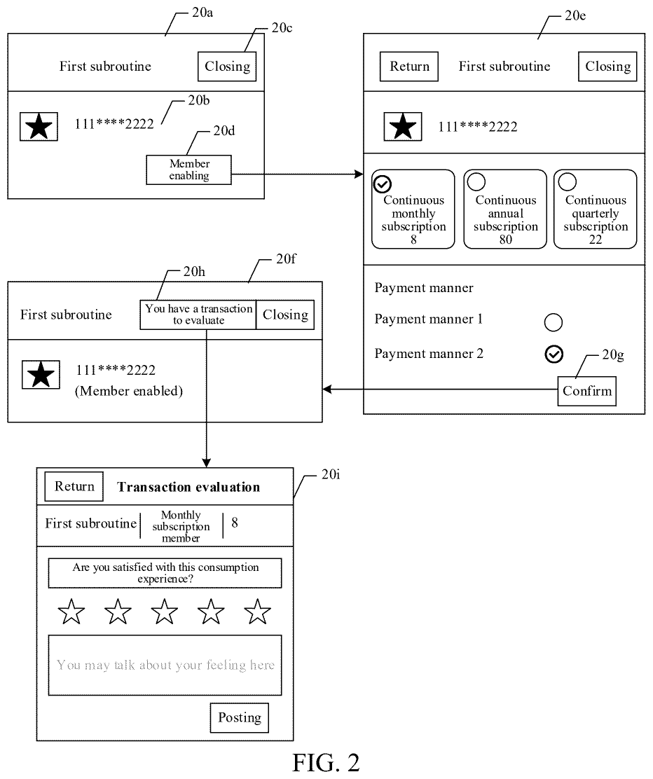

FIG. 2 is a schematic diagram of a data processing scenario according to an aspect of this disclosure. The aspect of this disclosure may be applied to various scenarios, including but not limited to cloud technologies, artificial intelligence, intelligent transportation, assistant driving, and the like. A specific service scenario is not limited in the aspect of this disclosure. An implementation process of the data processing scenario may be performed in a service server, or may be performed in a terminal device, or may be performed interactively in the terminal device and the service server. This is not limited herein. For case of description and understanding, the aspect of this disclosure is described with an example in which the implementation process is performed in the terminal device. The terminal device may be any terminal device in the terminal device cluster in the aspect corresponding to FIG. 1.

If the service object starts the first subroutine in the second application installed on the terminal device, the terminal device may display the first subroutine in the second application. A service platform to which the first subroutine belongs is not limited in the aspect of this disclosure, and therefore, a specific page on which the terminal device displays the first subroutine is not limited. The first subroutine is an embedded subclient such as a mini program. As shown in FIG. 2, for case of understanding and description, a member enabling page is used as an example in the aspect of this disclosure. On a member enabling page 20a, the terminal device may display an avatar of an application logged into by the service object in the first subroutine and an application account 20b. The application account 20b illustrated in FIG. 2 is 111****2222. In addition, the member enabling page 20a may further include a closing control 20c and a member enabling control 20d.

The closing control 20c is a function control that is provided by the second application and that has a fixed attribute. That is, as long as the service object starts the first subroutine in the second application, all pages displayed by the terminal device for the first subroutine each include a closing control 20c. That is, all pages provided by the first subroutine each include a closing control 20c. For example, the member enabling page 20a, a member enabling page 20c, and a service page 20f illustrated in FIG. 2 each include a closing control 20c. FIG. 2 provides the closing control 20c that is provided by the second application and that has a fixed attribute, to highlight the first service control provided in this disclosure. In addition, in an actual application scenario, the second application may provide one or more function controls that are provided for the first subroutine and that have a fixed attribute. The aspect of this disclosure is described with the fixed control 20c as an example. Further, if the service object triggers the closing control 20c, the terminal device closes the first subroutine in the second application in response to a trigger operation on the closing control 20c. That is, the terminal device quits displaying the first subroutine. Functions of a fixed control in any page in the first subroutine are the same, and are to close the first subroutine in the second application.

Application scenarios respectively corresponding to the second application and the first application (including the first subroutine) are not limited in the aspect of this disclosure. Therefore, the service function provided by the second application for the first application is not limited, and the first service operation is not limited. For case of description and understanding, FIG. 2 is described with an example in which the service function provided by the second application for the first application is a transaction payment function, and the first service operation is a member enabling operation. Still referring to FIG. 2, if the service object triggers the member enabling control 20d in the member enabling page 20a, the terminal device displays the member enabling page 20c in response to a trigger operation on the member enabling control 20d. The member enabling page 20e may include three candidate member types. The three candidate member types are respectively continuous monthly subscription, continuous annual subscription, and continuous quarterly subscription. A fee of the continuous monthly subscription is 8 digital resources, a fee of the continuous annual subscription is 80 digital resources, and a fec of the continuous quarterly subscription is 22 digital resources.

As shown in the member enabling page 20e, the first subroutine provides two payment manners, that is, a payment manner 1 and a payment manner 2. It is set that the payment manner 1 is provided by a service platform 1 (for example, a banking institution), and the payment manner 2 is provided by a service platform 2. The service platform 2 is a service platform corresponding to the second application. That is, the second application may provide a transaction payment function for the first subroutine.

Still referring to FIG. 2, if the service object selects the continuous monthly subscription and selects the payment manner 2, the terminal device may respond to a selection operation on the continuous monthly subscription and respond to a selection operation on the payment manner 2. In a scenario in which the service object triggers a confirmation control 20g in the member enabling page 20e, the terminal device may invoke the second application in response to a trigger operation on the confirmation control 20g, to perform a payment operation on a transaction that is for the continuous monthly subscription and that is initiated in the first subroutine in the second application. When the transaction payment succeeds, the terminal device may display the service page 20f in the first subroutine. The service page 20f displays that a member of the application account 111****2222 has been enabled. In addition, in the service page 20f, the terminal device may display a first service control 20h.

It can be learned from the above that in FIG. 2, the transaction payment operation is used as an example of the first service operation, and specific operations thereof may include a member enabling operation, a member selection operation, a payment manner operation, and the like. Therefore, if the first service operation performed by the service object in the first application or in the first subroutine embedded in the second application meets the control presentation condition, the terminal device may display the first service control 20h in the first subroutine in the second application. The first service control 20h is provided by the second application. However, a device delivering the first service control 20h may be the terminal device, or may be a service server corresponding to the second application, for example, the service server 100 shown in FIG. 1, or may be a service server corresponding to the first application, for example, the service server 102a shown in FIG. 1. The device delivering the first service control 20h may be arranged according to an actual application scenario. The first application in the aspect of this disclosure refers to a client that is not limited in application form, and includes, but is not limited to, a subclient (namely a first subroutine), an independent subclient, a web client, or the like. FIG. 2 is described with an example in which the service object performs the first service operation in the first subroutine. During actual application, if the service object performs the first service operation in an independent application client or in a web client, and the first service operation meets the control presentation condition, the terminal device may still display the first service control 20h in the first subroutine in the second application.

Still referring to FIG. 2, the terminal device may display the first service message in the first service control 20h. In the aspect of this disclosure, for example, the first service message is “You have a transaction to evaluate”. Similarly, the first service message is provided by the second application, and the first service message is associated with the first service operation. The first service message has a prompt function. Although the first service control 20h and the closing control 20c are both provided by the second application, different from the closing control 20c, in the aspect of this disclosure is, for example, a fixed attribute, the first service control 20h has a dynamic attribute. That is, the first service control 20h is not fixedly displayed, but is displayed in the first subroutine only when the first service operation of the service object meets the control presentation condition. A page in the first subroutine, in which the first service control 20h is displayed, is not limited in the aspect of this disclosure, and may be set according to an actual application scenario.

Because the first service control 20h has a dynamic attribute, the first service control has a total display duration threshold. For example, the second application sets the total display duration threshold of each display of the first service control 20h to 5 seconds, and when the first service control 20h starts to display, if the service object does not trigger the first service control 20h within 5 seconds, the terminal device eliminates the displayed first service control 20h after 5 seconds. For one first service operation, for example, the transaction payment operation illustrated in FIG. 2, the second application may set a display count of the first service control 20h to one or more. If the display count is one, after the terminal device displays the first service control 20h once, regardless of whether the service object triggers the first service control 20h, the terminal device does not display the first service control 20h again.

If the display count is a plurality, for example, 2, when the terminal device displays the first service control 20h for the first time, if the service object triggers the first service control 20h within 5 seconds, the terminal device may display the service page provided by the second application, for example, a service page 20i illustrated in FIG. 2. If the service object triggers a return control in the service page provided by the second application, the terminal device may return from the service page provided by the second application to the service page provided by the first subroutine, for example, the service page 20f illustrated in FIG. 2. In this case, the service page provided by the first subroutine no longer displays the first service control 20h. Because the terminal device already responds to the trigger operation on the first service control 20h, although the display count is 2, the terminal device no longer displays the first service control 20h for the second time.

Another scenario is that when the terminal device displays the first service control 20h for the first time, if the service object does not trigger the first service control 20h within 5 seconds, the terminal device eliminates the displayed first service control 20h after 5 seconds. Because the terminal device does not respond to the trigger operation on the first service control 20h, and the display count is 2, the first service control 20h may still be displayed once more, and the terminal device may display the first service control 20h for the second time. Logic of displaying the first service control 20h by the terminal device for the second time is the same as logic of displaying the first service control 20h by the terminal device for the first time. Therefore, details are not described again. Reference may be made to the foregoing descriptions.

If the display count of the first service control 20h is 3 or more, logic of displaying the first service control 20h by the terminal device is the same as logic of displaying the first service control 20h by the terminal device when the display count is 2. Therefore, details are not described in the aspect of this disclosure.

In addition, in a scenario in which the display count is a plurality, a display interval at which the terminal device displays the first service control 20h in the first subroutine is not limited in the aspect of this disclosure, and may be set according to an actual application scenario. However, a program state of the first subroutine is a started state. That is, the terminal device can display the first service control 20h in the first subroutine only when the service object starts the first subroutine in the second application. For example, when the first service operation meets the control presentation condition, the service object starts the first subroutine in the second application, and the terminal device may display the first service control 20h in the first subroutine in real time. If the service object does not trigger the first service control 20h within the total display duration threshold, the terminal device eliminates the displayed first service control 20h. Further, if duration during which the displayed first service control 20h is eliminated reaches display interval duration set by the second application, and the first subroutine is in a started state, the terminal device may display the first service control 20h for the second time. Subsequent display logic of the first service control 20h is the same as that described above. Therefore, details are not described. If duration during which the displayed first service control 20h is eliminated reaches the display interval duration set by the second application, and the first subroutine is in an unstarted state, when the service object starts the first subroutine in the second application again, the terminal device may display the first service control 20h for the second time. The terminal device displays the first service control 20h for the second time or displays the first service control 20h for multiple times on the premise that, the first service control 20h is not triggered by the service object, that is, the terminal device does not respond to a trigger operation on the first service control 20h.

Still referring to FIG. 2, the terminal device displays, in response to the trigger operation on the first service control 20h, the service page 20i provided by the second application. The service page 20i illustrated in the aspect of this disclosure is a transaction evaluation page, that is, the page is associated with the first service operation illustrated in FIG. 2 that is used as a transaction payment operation. The service page 20i is configured by the service object to perform a transaction evaluation operation on the member enabling transaction illustrated in FIG. 2. That is, in the aspect of this disclosure, the second service operation is, for example, a transaction evaluation operation.

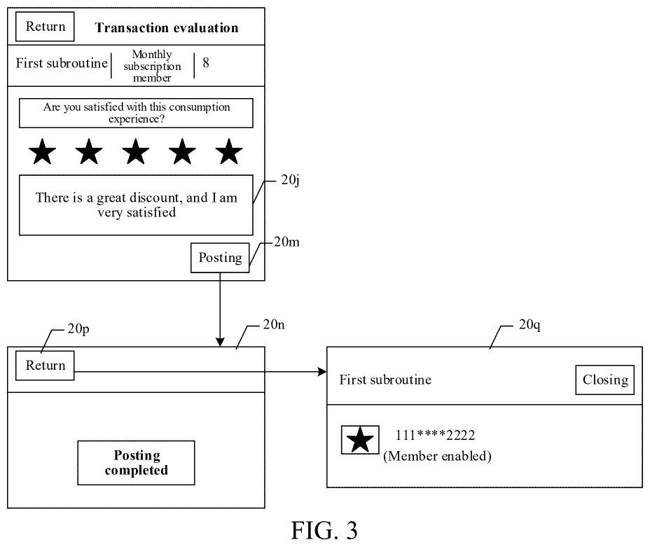

The service page 20i may include detailed data of the member enabling transaction. The detailed data includes an object of a member (for example, the first subroutine in FIG. 2), a member type (for example, a monthly subscription member in FIG. 2), and a member fec (for example, 8 digital resources in FIG. 2). The service page 20i may include an evaluation manner. Star level evaluation and text evaluation are used as an example in the aspect of this disclosure. The service object may input evaluation information in the service page 20i, and the terminal device obtains input information in response to an input operation on the service page 20i. Referring to FIG. 3, FIG. 3 is a schematic diagram of another data processing scenario according to an aspect of this disclosure. As shown in FIG. 3, the service object selects five-star positive comments, and inputs an evaluation text 20j in a text box, that is, “There is a great discount, and I am very satisfied” in FIG. 3.

Further, if the service object triggers a posting control 20m, the terminal device determines, in response to a trigger operation on the posting control 20m in the second application, information (for example, the five-star positive comments and the evaluation text 20j in FIG. 3) inputted by the service object as the second service message. The second application may transmit the second service message to the first application, and the service object may view, in the first application (including the first subroutine in the second application), evaluation performed by the service object on the member enabling transaction.

Still referring to FIG. 3, if the second service message is successfully posted through the second application, the terminal device may display a service page 20n, and the service page 20n may display a prompt message configured for prompting that the second service message is successfully posted, for example, “Posting completed” illustrated in the service page 20n. Both the service page 20i and the service page 20n are provided by the second application. Therefore, both the service page 20i and the service page 20n include no first service control. Further, if the service object triggers a return control 20p in the service page 20n, the terminal device returns, in response to a trigger operation on the return control 20p, from the service page 20n provided by the second application to the first subroutine, for example, the service page 20q illustrated in FIG. 3. No first service control is displayed in the service page 20q. The service page 20f in FIG. 2 and the service page 20q in FIG. 3 are compared, and differ in that the service page 20q does not display the first service control 20h because the service object triggers the first service control 20h in the service page 20f.

Interfaces and controls shown in FIG. 2 are merely some representation forms for reference. In an actual service scenario, a developer may perform a related design according to a product requirement. Specific forms of interfaces and controls involved are not limited in the aspect of this disclosure.

Further, FIG. 4 is a schematic flowchart of a data processing method according to an aspect of this disclosure. The data processing method may be performed by a service server (for example, the service server 100 shown in FIG. 1), or may be performed by a terminal device (for example, the terminal device 101a shown in FIG. 1), or may be performed interactively by a service server and a terminal device. For case of understanding, the aspect of this disclosure is described with an example in which the method is performed by a terminal device. As shown in FIG. 4, the image data processing method may include at least the following operations S101 and S102:

Operation S101: Display, if a first service operation performed by a service object in a first application or a first subroutine embedded in a second application meets a control presentation condition, a first service control in the first subroutine in the second application, where the first service operation is implemented through a service function provided by the second application; the first service control is provided by the second application; and a service platform corresponding to the first application is the same as a service platform corresponding to the first subroutine. For example, a first service control element in a first subprogram in a second application is output for display based on a determination that a first service operation initiated by a user satisfies a display condition. The first service operation is initiated in a first application or in the first subprogram embedded in the second application. The first service operation is executed through a service function provided by the second application. The first service control element is provided by the second application. The first subprogram corresponds to the first application. A service platform corresponding to the first application is different from a service platform corresponding to the second application.

For example, a response is made to the first service operation performed by the service object in the first application or in the first subroutine; and the first service control is displayed in the first subroutine in the second application at a first moment if the first service operation meets the control presentation condition.

For example, a response is made to the first service operation performed by the service object in the first application or in the first subroutine; and the first service control is displayed on a current page of the first subroutine at a third moment if the first service operation meets the control presentation condition, where the first subroutine is a subroutine in the second application.

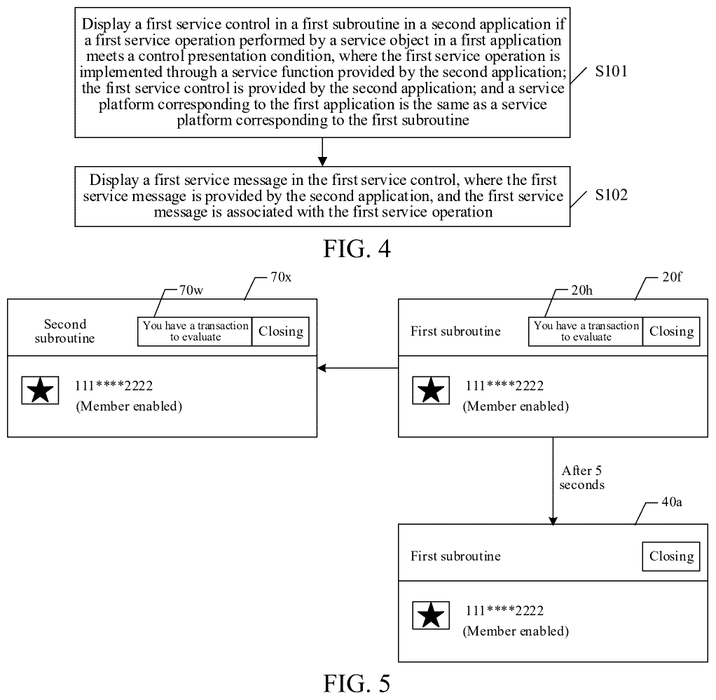

Application scenarios corresponding to the first application and the second application respectively are not limited in the aspect of this disclosure. Therefore, content of the first service operation is not limited, and may be set according to an actual application scenario. For case of understanding and description, FIG. 5 is a schematic diagram of another data processing scenario according to an aspect of this disclosure. For the meaning and a display relationship of the service page 20f displayed by the terminal device in the first subroutine in the second application, reference may be made to the descriptions in the aspect corresponding to FIG. 2, and details are not described herein.

It is set that the terminal device displayed the service page 20f at 12:01:01 on Jun. 23, 2023, and it is set that the total display duration threshold of the first service control 20h is 5 seconds. If the service object triggers no first service control 20h in a period from 12:01:01 on Jun. 23, 2023 to 12:01:05 on Jun. 23, 2023, the terminal device eliminated the displayed first service control 20h at a next moment after 12:01:05 on Jun. 23, 2023, as shown in a service page 40a illustrated in FIG. 5.

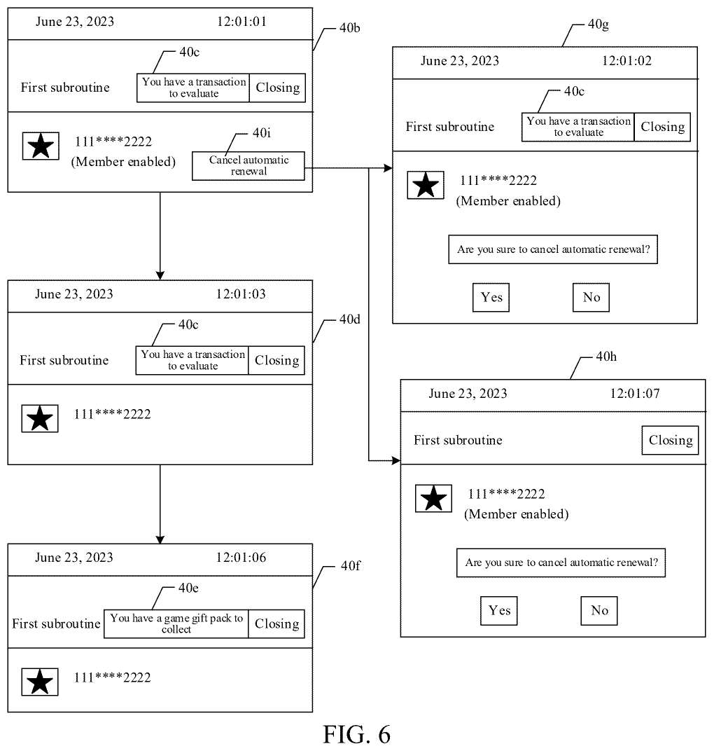

Further, FIG. 6 is a schematic diagram of another data processing scenario according to an aspect of this disclosure. The terminal device displays a service page 40b at 12:01:01 on Jun. 23, 2023. For the meaning and a display relationship of the service page 40b, reference may be made to the descriptions in the aspect corresponding to FIG. 2, and details are not described herein. In addition, the service page 40b illustrated in FIG. 6 may include a control 40i for cancellation of automatic renewal. With reference to FIG. 2, it may be learned that a member enabled by the service object for the first application (including the first subroutine in the second application) is of a continuous monthly subscription type. In the aspect of this disclosure, any subroutine is an embedded subclient, for example, a mini program.

It is set that the first moment and the third moment are both 12:01:01 on Jun. 23, 2023 illustrated in FIG. 6.

Interfaces and controls shown in FIG. 5 and FIG. 6 are merely some representation forms for reference. In an actual service scenario, a developer may perform a related design according to a product requirement. Specific forms of interfaces and controls involved are not limited in the aspect of this disclosure.

Operation S102: Display a first service message in the first service control, where the first service message is provided by the second application, and the first service message is associated with the first service operation. For example, a first service message in the first service control element is output for display. The first service message is provided by the second application and is associated with the first service operation.

For example, statistics is collected on continuous display duration of the first service control, and the displayed first service control is eliminated if the continuous display duration is equal to a total display duration threshold.

For example, a response is made at a second moment to a third service operation performed by the service object in the first application or in the first subroutine; a time difference between the second moment and the first moment is determined if the third service operation meets the control presentation condition, where the third service operation is implemented through a service function provided by the second application; and the first service control is continuously displayed in the first subroutine if the time difference is less than the total display duration threshold, or the first service control is displayed as a second service control in the first subroutine in an updated manner, and a third service message is displayed in the second service control, if the time difference is equal to the total display duration threshold, where the second service control is provided by the second application; the third service message is provided by the second application, and the third service message is associated with the third service operation, or the second service control is displayed in the first subroutine, and the third service message is displayed in the second service control, if the time difference is greater than the total display duration threshold.

For example, the current page is displayed as a current updated page in an updated manner at a fourth moment in response to a page update operation on the current page, where the fourth moment is later than the third moment; and the first service control is kept displaying on the current updated page if a time difference between the fourth moment and the third moment is less than the total display duration threshold.

The first service operation and the third service operation may be the same. For example, the first service operation is a transaction payment operation, and the third service operation is also a transaction payment operation, but a transaction payment event targeted by the first service operation is different from a transaction payment event targeted by the third service operation. For example, in FIG. 2, the first service operation is that the service object enables a member of the first application, and the third service operation may be a transaction payment operation performed by the service object for another event in the first application. In some aspects, the first service operation and the third service operation may be different. For example, the first service operation is a transaction payment operation, while the third service operation is an account login operation. Still referring to FIG. 6, a third service operation illustrated in FIG. 6 is an account login operation, namely an operation that the service object logs in to an application account in the first application (including the first subroutine). In this case, the first service operation is different from the third service operation.

The aspect of this disclosure is described with an example in which the first application is a first subroutine. At the first moment, the terminal device displays a first service control 40c in the first subroutine in the second application. In FIG. 6, 12:01:01 on Jun. 23, 2023 is used as an example of the first moment. It is set that a total display duration threshold (which may be adjusted) of the first service control 40c is 5 seconds. If the service object still did not trigger the first service control 40c at 12:01:03 on Jun. 23, 2023, the terminal device keeps displaying the first service control 40c, as shown in a service page 40d in FIG. 6.

A time sequence of the second moment and the first moment is not limited in the aspect of this disclosure. During actual application, the first moment may be earlier than the second moment, or the first moment may be equal to the second moment, or the first moment may be later than the second moment.

Because the terminal device already displays the first service control 40c in the service page 40b of the first subroutine, if the third service operation meets the control presentation condition, the second service control needs to be displayed after the displayed first service operation 40c is eliminated. As shown in FIG. 6, if the service object did not trigger the first service control 40c within 12:01:01 on Jun. 23, 2023 to 12:01:05 on Jun. 23, 2023, the terminal device kept displaying the first service control 40c in the first subroutine until 12:01:06 on Jun. 23, 2023. The terminal device displays the first service control 40c in an updated manner as a second service control 40e in the first subroutine, as shown in a service page 40f in FIG. 6. In the aspect of this disclosure, the third service message in the second service control 40c is, for example, “You have a game gift pack to collect”. A display position of the first service control 40c is the same as a display position of the second service control 40e. It can be learned from the above that the second application in the aspect of this disclosure may not only provide a service control having a dynamic attribute for the first subroutine, but also provide service controls with different service functions. For example, the first service control is a transaction evaluation control, and the second service control is a game gift pack collection control.

Referring to FIG. 6, in the aspect of this disclosure, the third moment is set as 12:01:01 on Jun. 23, 2023 in the service page 40b. As shown in FIG. 6, the service object triggers the control 40i for cancellation of automatic renewal in the service page 40b, and the terminal device displays, in response to a page update operation on a current page (namely the service page 40b) at a fourth moment (for example, 12:01:02 on Jun. 23, 2023 in FIG. 6), the current page in an updated manner as a current updated page, namely a service page 40g illustrated in FIG. 6. The total display duration threshold of the first service control 40c is set as 5 seconds above. Because a time difference between the fourth moment (for example, 12:01:02 on Jun. 23, 2023 in FIG. 6) and the third moment (for example, 12:01:01 on Jun. 23, 2023 in FIG. 6) is 1 second, the terminal device keeps displaying the first service control 40c in the first subroutine. Specific content of each service page needs to be set according to an actual application scenario, and is not limited in the aspect of this disclosure. The service page 40g in FIG. 6 includes a message prompting the service object to confirm whether to cancel automatic renewal, and a “Yes” option and a “No” option for answering the foregoing question.

If the time difference between the fourth moment and the third moment is equal to or greater than the total display duration threshold, the terminal device displays the service page 40h in the first subroutine. In this case, the fourth moment is, for example, 12:01:07 on Jun. 23, 2023, that is, the time difference between the fourth moment and the third moment is 6 seconds. Therefore, the terminal device updates the current page, and eliminates the displayed first service control 40c. It can be learned from the above that, the first service control provided in the aspect of this disclosure may be displayed in different service pages within the total display duration threshold. Therefore, a presentation effect of the first service control can be improved, thereby better prompting the service object to perform the second service operation.

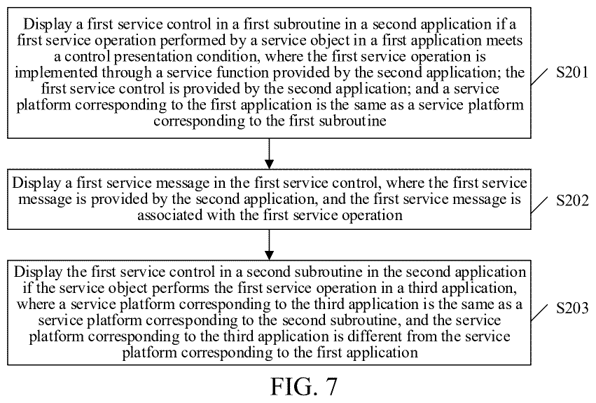

Further, FIG. 7 is a schematic flowchart of another data processing method according to an aspect of this disclosure. The method may be performed by a service server (for example, the service server 100 shown in FIG. 1), or may be performed by a terminal device (for example, the terminal device 101a shown in FIG. 1), or may be performed interactively by a service server and a terminal device. For case of understanding, the aspect of this disclosure is described with an example in which the method is performed by a terminal device. As shown in FIG. 7, the method may include at least the following operations S201 to S203:

Operation S201: Display, if a first service operation performed by a service object in a first application or a first subroutine embedded in a second application meets a control presentation condition, a first service control in the first subroutine in the second application, where the first service operation is implemented through a service function provided by the second application; the first service control is provided by the second application; and the first subroutine is a subroutine corresponding to the first application, a service platform corresponding to the first application is the same as a service platform corresponding to the first subroutine, and the service platform corresponding to the first application is different from a service platform corresponding to the second application. For example, a first service control element in a first subprogram in a second application is output for display based on a determination that a first service operation initiated by a user satisfies a display condition. The first service operation is initiated in a first application or in the first subprogram embedded in the second application. The first service operation is executed through a service function provided by the second application. The first service control element is provided by the second application. The first subprogram corresponds to the first application. A service platform corresponding to the first application is different from a service platform corresponding to the second application.

For example, a first brightness mode of the second application is determined, and the first service control is displayed in the first brightness mode in the first subroutine.

To improve a presentation effect of a page and satisfy visual effects of the service object in different scenarios, the first service control may be displayed in different brightness modes. For example, the service object starts the first subroutine in a scenario in which there is illumination. In this case, the terminal device is in a light mode (LM), which may also be referred to as a day mode. Therefore, the second application and the first subroutine are both in the day mode. Therefore, the first service control is displayed in the day mode. For example, the service object starts the first subroutine in a scenario in which there is no illumination. In this case, the terminal device is in a dark mode (DM), which may also be referred to as a night mode. Therefore, the second application and the first subroutine are both in the night mode. Therefore, the first service control is displayed in the night mode. It can be learned from the above that the brightness mode of the first service control is the same as the brightness modes of the first subroutine and the second application, and the first brightness mode includes the foregoing day mode or night mode.

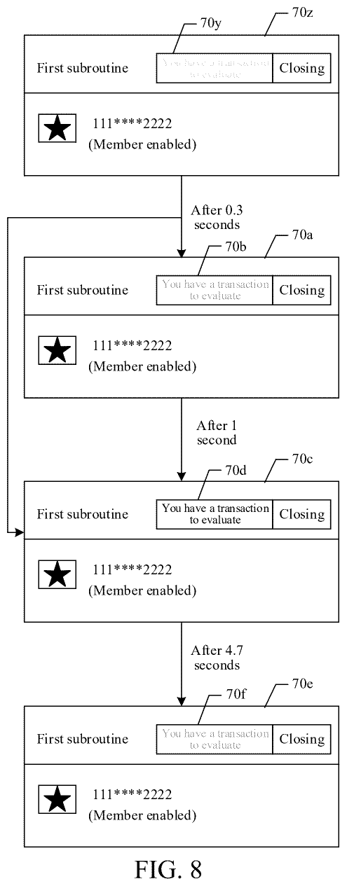

Further, FIG. 8 is a schematic diagram of another data processing scenario according to an aspect of this disclosure. As shown in FIG. 8, the terminal device displays, in the first subroutine of the second application, a service page 70z in the day mode, and a first service control 70y in the day mode.

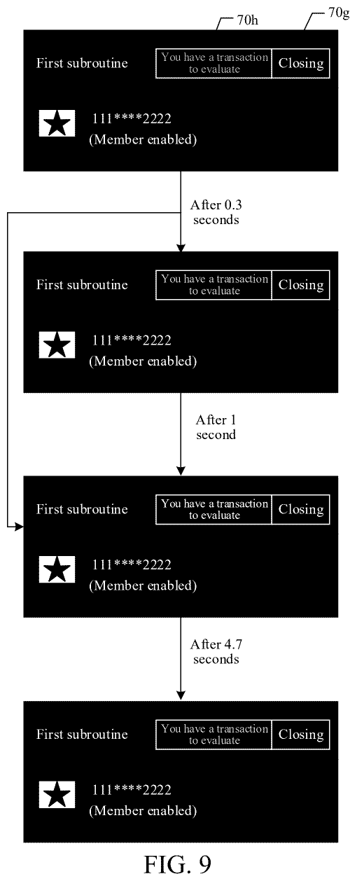

Further, FIG. 9 is a schematic diagram of another data processing scenario according to an aspect of this disclosure. As shown in FIG. 9, the terminal device displays, in the first subroutine of the second application, a service page 70g in the night mode, and a first service control 70h in the night mode.

Operation S202: Display a first service message in the first service control, where the first service message is provided by the second application, and the first service message is associated with the first service operation. For example, a first service message in the first service control element is output for display. The first service message is provided by the second application and is associated with the first service operation.

For example, the first service message is displayed in a second brightness mode in the first service control, where the second brightness mode is different from the first brightness mode.

A specific process of displaying the first service message in the second brightness mode may include: continuously displaying the first service message through a first visual parameter, where the first visual parameter is a visual parameter in the first brightness mode; collecting statistics on first display duration during which the first service message is continuously displayed through the first visual parameter; performing visual parameter change processing on the first service message starting from the first visual parameter when the first display duration is greater than a first display duration threshold; and dynamically displaying the first service message through a changed visual parameter, and stopping the visual parameter change processing when the changed visual parameter reaches a second visual parameter, where the second visual parameter is a visual parameter in the second brightness mode.

A specific process of displaying the first service message in the second brightness mode may further include: continuously displaying the first service message through the second visual parameter when the changed visual parameter reaches the second visual parameter; collecting statistics on second display duration during which the first service message is continuously displayed through the second visual parameter; performing reverse visual parameter change processing on the first service message starting from the second visual parameter when the second display duration is greater than a second display duration threshold; dynamically displaying the first service message through a reversely changed visual parameter, and stopping the reverse visual parameter change processing when the reversely changed visual parameter reaches the first visual parameter, where the second display duration threshold is greater than the first display duration threshold; continuously displaying the first service message through the first visual parameter when the reversely changed visual parameter reaches the first visual parameter; collecting statistics on third display duration during which the first service message is continuously displayed through the first visual parameter; and eliminating the displayed first service message when the third display duration is greater than a third display duration threshold, where the third display duration threshold is less than the first display duration threshold.

To improve a presentation effect of a page and satisfy visual effects of the service object in different scenarios, a brightness mode corresponding to the first service message is different from a brightness mode corresponding to the first service control. It has been stated above that the first brightness mode may be the day mode, and the second brightness mode different from the first brightness mode is the night mode, or the first brightness mode may be the night mode, and the second brightness mode different from the first brightness mode is the day mode.

Still referring to FIG. 8, it is illustrated in FIG. 8 that, the first brightness mode is a day mode, and the second brightness mode is a night mode. The terminal device starts to display the first service message in the service page 70z of the first subroutine of the second application through the first visual parameter, for example, “You have a transaction to evaluate” in the first service control 70y illustrated in FIG. 8. For the first brightness mode (the day mode herein) of the service page 70z, the first service message is gradually displayed from transparency to non-transparency. Therefore, the first visual parameter is a visual parameter in the first brightness mode. Because it is illustrated in FIG. 8 that the first brightness mode is the day mode, the first visual parameter herein is a visual parameter in the day mode. That is, the first service message is gradually displayed from a white visual parameter to a black visual parameter.

As shown in FIG. 8, the terminal device starts to display the first service message through the first visual parameter (for example, a white transparency parameter), then keeps displaying the first service message through the first visual parameter, and performs, when duration during which the first service message is displayed through the first visual parameter reaches a first display duration threshold (for example, 0.3 s in FIG. 8, the second application may adjust the threshold), visual parameter change processing on the first service message starting from the first visual parameter (for example, the white transparency parameter), that is, slowly changes from white transparency to black non-transparency. As shown in a service page 70a in FIG. 8, a visual parameter of a first service message in a first service control 70b is different from a visual parameter of a first service message in a first service control 70y. In addition, transparency of the first service message in the first service control 70b is lower than transparency of the first service message in the first service control 70y. Further, when total display duration of the first service message reaches one second, the first service message is displayed through the second visual parameter. As shown in a service page 70c in FIG. 8, a first service message in a first service control 70d is in a non-transparent state.

The terminal device keeps displaying the first service message through the second visual parameter (for example, a black non-transparency parameter), until the total display duration of the first service message reaches 4.7 seconds, and then the terminal device performs reverse visual parameter change processing on the first service message starting from the second visual parameter, and dynamically displays the first service message through a reversely changed visual parameter. As shown in a service page 70e in FIG. 8, a visual parameter of a first service message in a first service control 70f is different from a visual parameter of the first service message in the first service control 70d, and transparency of the first service message in the first service control 70f is higher than transparency of the first service message in the first service control 70d. The first service message is continuously displayed through the first visual parameter when the reversely changed visual parameter reaches the first visual parameter; statistics is collected on third display duration during which the first service message is continuously displayed through the first visual parameter; and the displayed first service message is eliminated when the third display duration is greater than the third display duration threshold.

In some aspects, when the first display duration is greater than the first display duration threshold, for example, 0.3 second shown in FIG. 8, the terminal device may directly adjust the first visual parameter to the second visual parameter, that is, directly display the first service message by using the second visual parameter.

FIG. 8 is described with an example in which the first brightness mode is a day mode and the second brightness mode is a night mode. A principle of FIG. 9 is the same as that of FIG. 8. A difference lies in that FIG. 9 uses an example in which the first brightness mode is a night mode and the second brightness mode is a day mode. Therefore, FIG. 9 is not described herein, and reference may be made to the foregoing descriptions.

Operation S203: Display the first service control in the second subroutine in the second application if the service object performs the first service operation in a third application or in the second subroutine embedded in the second application, where the second subroutine is a subroutine corresponding to the third application, a service platform corresponding to the third application is the same as a service platform corresponding to the second subroutine, the service platform corresponding to the third application is different from the service platform corresponding to the first application, and the service platform corresponding to the third application is different from the service platform corresponding to the second application. For example, the first service control element in a second subprogram in the second application is output for display based on the user performing the first service operation in a third application or in the second subprogram embedded in the second application. The second subprogram corresponds to the third application. A service platform corresponding to the third application is different from the service platform corresponding to the second application. The service platform corresponding to the third application is different from the service platform corresponding to the first application.

For example, a plurality of subroutines corresponding to different service platforms respectively may be embedded in the second application. The plurality of subroutines may include a first subroutine and a second subroutine. For example, the first application (including the first subroutine) is a convenient-life application, the third application (including the second subroutine) is a video application, and the second application is a transaction application. The second application in the aspect of this disclosure may not only provide a transaction payment function for the first application, but also provide a transaction payment function for the third application. Therefore, the aspect of this disclosure may not only provide a transaction payment function for the first subroutine, but also provide a transaction payment function for the second subroutine.

The process in which the service object performs the first service operation in the third application is similar to the process in which the service object performs the first service operation in the first application. Therefore, reference may be made to the descriptions in the aspect corresponding to FIG. 2. Details are not described herein. Still referring to FIG. 5, if the service object performs the first service operation in the third application, when the service object starts the second subroutine in the second application, the terminal device may display a service page 70x in the second subroutine. The service page 70x may display a first service control 70w. The first service control 70w and the first service control 20h in the service page 20f have the same function, and differ in that targeted transaction events are different. It can be learned from the above that the first service control provided by the second application in the aspect of this disclosure may be embedded in subroutines respectively corresponding to different service platforms, that is, the service object may perform the same service operation in different applications, so that the same service control may be displayed in different subroutines. Therefore, through the first service control provided in the aspect of this disclosure, different service platforms can be prevented from developing service controls respectively, thereby improving service function efficiency of each service platform and reducing development costs.

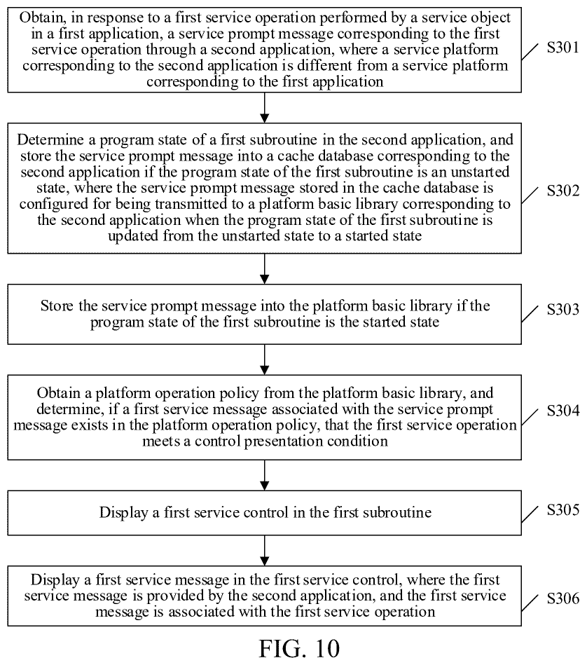

Further, FIG. 10 is a schematic flowchart of another data processing method according to an aspect of this disclosure. The method may be performed by a service server (for example, the service server 100 shown in FIG. 1), or may be performed by a terminal device (for example, the terminal device 101a shown in FIG. 1), or may be performed interactively by a service server and a terminal device. For case of understanding, the aspect of this disclosure is described with an example in which the method is performed by a terminal device. As shown in FIG. 10, the method may include at least the following operations S301 to S306:

Operation S301: Obtain, in response to a first service operation performed by a service object in a first application or a first subroutine embedded in a second application, a service prompt message corresponding to the first service operation through the second application, where a service platform corresponding to the second application is different from a service platform corresponding to the first application. For example, a service prompt message corresponding to the first service operation through the second application is obtained based on the user performing the first service operation in the first application or in the first subprogram.

For example, the first service operation is implemented through a service function provided by the second application; the first service control is provided by the second application; and the service platform corresponding to the first application is the same as a service platform corresponding to the first subroutine.

The second application may be installed on the terminal device. The second application is an independent application client in which a subroutine may be embedded. Therefore, the second application may include one or more subroutines, and the one or more subroutines include the first subroutine.

The first application includes the first subroutine. The first application may further include an independent application client, and may further include a web application client. An application form of the first application is not limited in the aspect of this disclosure, and may be set according to an actual application scenario. Any subroutine in this disclosure is an embedded subclient, for example, a mini program.

A service function provided by the second application may be embedded in the first application. For example, the first application is a convenient-life application, the second application is a transaction application, and the second application may provide a transaction payment function for the first application. Therefore, the service object may perform a transaction payment operation in the first application through the transaction payment function provided by the second application. When the transaction payment operation is completed, the second application may obtain a service prompt message, such as a transaction payment prompt message, corresponding to the transaction payment operation, and the transaction payment prompt message may be transmitted to the first application through the second application.

Operation S302: Determine a program state of the first subroutine in the second application, and store the service prompt message into a cache database corresponding to the second application if the program state of the first subroutine is an unstarted state, where the service prompt message stored in the cache database is configured for being transmitted to a platform basic library corresponding to the second application when the program state of the first subroutine is updated from the unstarted state to a started state. For example, a program state of the first subprogram in the second application is determined. The service prompt message is stored in a cache database corresponding to the second application when the program state of the first subprogram is an unstarted state. The service prompt message stored in the cache database is transmitted to a platform base library corresponding to the second application when the program state changes from the unstarted state to a started state.

For example, if the terminal device obtains the service prompt message through the second application, the service prompt message may be displayed in the second application.

In addition, the terminal device may store no service prompt message. In this case, a service server corresponding to the second application, for example, the service server 100 in FIG. 1, may first perform operation S304 described below, to determine a first service message, and then the service server delivers the first service message to the terminal device. When obtaining the first service message, the terminal device determines a program state of the first subroutine. If the program state of the first subroutine is an unstarted state, the terminal device stores the first service message into the cache database corresponding to the second application. The first service message stored in the cache database is configured for being transmitted to a platform basic library corresponding to the second application when the program state of the first subroutine is updated from the unstarted state to a started state.

Operation S303: Store the service prompt message into the platform basic library if the program state of the first subroutine is the started state. For example, the service prompt message is stored in the platform base library when the program state of the first subprogram is the started state.

For example, a program index of the first subroutine is obtained, and a message index table stored in association with the program index is obtained from the platform basic library; and a message identifier of the service prompt message is obtained, and the message identifier and the service prompt message are stored into the message index table in association if no historical service prompt message having an index relationship with the message identifier exists in the message index table, or if a historical service prompt message having an index relationship with the message identifier exists in the message index table, the historical service prompt message in the message index table is updated to the service prompt message.

A specific process of displaying the first service control in the first subroutine may include: obtaining, from the platform operation policy, a presentation manner associated with the service prompt message and a presentation condition associated with the service prompt message; and displaying the first service control in the presentation manner in the first subroutine when the first service control meets the presentation condition.

In the aspect of this disclosure, for different service operations (which may be understood as different service functions), the platform basic library is configured to store a current service prompt message. That is, for a service function, if a new service prompt message exists, the platform basic library deletes an old service prompt message, and then stores the new service prompt message.

According to the description of operation S302, the terminal device may not store the service prompt message into the platform basic library. In this case, the terminal device stores the first service message delivered by the service server into the platform basic library. Logic for storing the first service message is the same as logic for storing the service prompt message into the platform basic library. That is, the platform basic library stores only the current first service message, and if an old service message exists, the old service message is deleted to store the current first service message.

Operation S304: Obtain a platform operation policy from the platform basic library, and determine, if the first service message associated with the service prompt message exists in the platform operation policy, that the first service operation meets the control presentation condition. For example, a platform operation policy is obtained from the platform base library. The first service operation is determined to satisfy the display condition when the platform operation policy includes the first service message associated with the service prompt message.

For example, if the first service message delivered by the service server is obtained, the terminal device may determine that the first service operation meets the control presentation condition.

The control presentation condition not only includes a service operation preset by the second application, but also is related to completion of a service event. For example, if the first service operation is a transaction payment operation, the control presentation condition includes completion of a service transaction. Therefore, specific content of the control presentation condition is not limited in the aspect of this disclosure, and needs to be set according to an actual application scenario.

Operation S305: Display the first service control in the first subroutine. For example, the first service control element in the first subprogram is output for display.

Operation S306: Display a first service message in the first service control, where the first service message is provided by the second application, and the first service message is associated with the first service operation. For example, a first service message in the first service control element is output for display. The first service message is provided by the second application and is associated with the first service operation.

For a specific implementation process of operations S305 and S306, reference may be made to the descriptions in the aspects corresponding to FIG. 2, FIG. 3, FIG. 4, and FIG. 7 respectively, and details are not described herein.

The aspects involved in this disclosure, for example, the aspects corresponding to FIG. 2, FIG. 3, FIG. 4, FIG. 7, and FIG. 10 respectively, may be combined to generate new aspects.

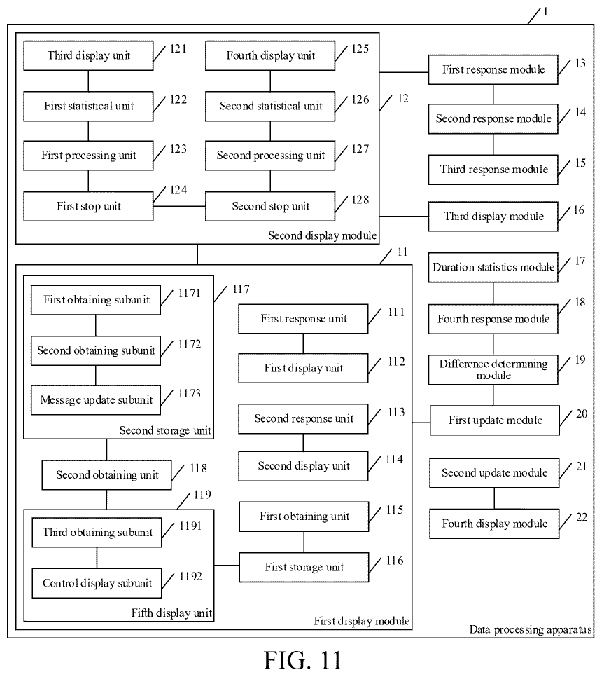

Further, FIG. 11 is a schematic structural diagram of a data processing apparatus according to an aspect of this disclosure. A data processing apparatus 1 may be configured to perform the corresponding operations in the method according to the aspects of this disclosure. As shown in FIG. 11, the data processing apparatus 1 may include a first display module 11 and a second display module 12.

The first display module 11 is configured to display, in response to that a first service operation performed by a service object in a first application or a first subroutine embedded in a second application meets a control presentation condition, a first service control in the first subroutine in the second application, where the first service operation is implemented through a service function provided by the second application; the first service control is provided by the second application; and the first subroutine is a subroutine corresponding to the first application, a service platform corresponding to the first application is the same as a service platform corresponding to the first subroutine, and the service platform corresponding to the first application is different from a service platform corresponding to the second application.

The second display module 12 is configured to display a first service message in the first service control, where the first service message is provided by the second application, and the first service message is associated with the first service operation.

For a specific manner of functional implementation of the first display module 11 and the second display module 12, reference may be made to operations S101 and S102 in the aspect corresponding to FIG. 4. Details are not described herein.

Still referring to FIG. 11, the data processing apparatus 1 may further include a first response module 13.

The first response module 13 is configured to display, in response to a trigger operation on the first service control, a service page provided by the second application, where the service page is configured for the service object to perform a second service operation associated with the first service operation.

For a specific manner of functional implementation of the first response module 13, reference may be made to the descriptions in the aspect corresponding to FIG. 2. Details are not described herein.

Still referring to FIG. 11, the data processing apparatus 1 may further include a second response module 14 and a third response module 15.

The second response module 14 is configured to obtain input information in response to an input operation on the service page, and determine the input information as a second service message, where the second service message is transmitted by the second application to the first application.

The third response module 15 is configured to return to the first subroutine from the service page in response to a trigger operation on a return control in the service page, and cancel displaying the first service control in the first subroutine.

For a specific manner of functional implementation of the second response module 14 and the third response module 15, reference may be made to the descriptions in the aspect corresponding to FIG. 2. Details are not described herein.

Still referring to FIG. 11, the data processing apparatus 1 may further include a third display module 16.

The third display module 16 is configured to display the first service control in the second subroutine in the second application in response to that the service object performs the first service operation in a third application or in the second subroutine embedded in the second application, where the second subroutine is a subroutine corresponding to the third application, a service platform corresponding to the third application is the same as a service platform corresponding to the second subroutine, and the service platform corresponding to the third application is different from the service platform corresponding to the first application.

For a specific manner of functional implementation of the third display module 16, reference may be made to operation S203 in the aspect corresponding to FIG. 7. Details are not described herein.

Still referring to FIG. 11, the data processing apparatus 1 may further include a duration statistics module 17.

The duration statistics module 17 is configured to collect statistics on continuous display duration of the first service control, and eliminate the displayed first service control if the continuous display duration is equal to a total display duration threshold.

For a specific manner of functional implementation of the duration statistics module 17, reference may be made to operation S102 in the aspect corresponding to FIG. 4. Details are not described herein.

Still referring to FIG. 11, the first display module 11 may include a first response unit 111 and a first display unit 112.

The first response unit 111 is configured to respond to the first service operation performed by the service object in the first application or in the first subroutine embedded in the second application;

the first display unit 112 is configured to display the first service control in the first subroutine in the second application at a first moment if the first service operation meets the control presentation condition; and

the data processing apparatus 1 may further include a fourth response module 18, a difference determining module 19, and a first update module 20.

The fourth response module 18 is configured to respond at a second moment to a third service operation performed by the service object in the first application or in the first subroutine.

The difference determining module 19 is configured to determine a time difference between the second moment and the first moment if the third service operation meets the control presentation condition, where the third service operation is implemented through a service function provided by the second application.

The first display module 11 is further configured to continuously display the first service control in the first subroutine if the time difference is less than the total display duration threshold.

The first update module 20 is configured to display the first service control as a second service control in the first subroutine in an updated manner, and display a third service message in the second service control, if the time difference is equal to the total display duration threshold, where the second service control is provided by the second application; and the third service message is provided by the second application, and the third service message is associated with the third service operation.

The first display module 11 is further configured to display the second service control in the first subroutine, and display the third service message in the second service control, if the time difference is greater than the total display duration threshold.

For a specific manner of functional implementation of the first response unit 111, the first display unit 112, the fourth response module 18, the difference determining module 19, and the first update module 20, reference may be made to operation S102 in the aspect corresponding to FIG. 4. Details are not described herein.

Still referring to FIG. 11, the first display module 11 may include a second response unit 113 and a second display unit 114.

The second response unit 113 is configured to respond to the first service operation performed by the service object in the first application or in the first subroutine;

the second display unit 114 is configured to display the first service control on a current page of the first subroutine at a third moment if the first service operation meets the control presentation condition, where the first subroutine is a subroutine in the second application; and

the data processing apparatus 1 may further include a second update module 21 and a fourth display module 22.

The second update module 21 is configured to display the current page as a current updated page in an updated manner at a fourth moment in response to a page update operation on the current page, where the fourth moment is later than the third moment.

The fourth display module 22 is configured to keep displaying the first service control on the current updated page if a time difference between the fourth moment and the third moment is less than the total display duration threshold.

For a specific manner of functional implementation of the second response unit 113, the second display unit 114, the second update module 21, and the fourth display module 22, reference may be made to operation S102 in the aspect corresponding to FIG. 4. Details are not described herein.

Still referring to FIG. 11, the first display module 11 is configured to determine a first brightness mode of the second application, and display the first service control in the first brightness mode in the first subroutine; and

the second display module 12 is configured to display a first service message in a second brightness mode in the first service control, where the second brightness mode is different from the first brightness mode.

For a specific manner of functional implementation of the first display module 11 and the second display module 12, reference may be made to operations S201 and S202 in the aspect corresponding to FIG. 7. Details are not described herein.

Still referring to FIG. 11, the second display module 12 may include a third display unit 121, a first statistical unit 122, a first processing unit 123, and a first stop unit 124.

The third display unit 121 is configured to continuously display the first service message through a first visual parameter, where the first visual parameter is a visual parameter in the first brightness mode.

The first statistical unit 122 is configured to collect statistics on first display duration during which the first service message is continuously displayed through the first visual parameter.

The first processing unit 123 is configured to perform visual parameter change processing on the first service message starting from the first visual parameter when the first display duration is greater than a first display duration threshold.

The first stop unit 124 is configured to dynamically display the first service message through a changed visual parameter, and stop the visual parameter change processing when the changed visual parameter reaches a second visual parameter, where the second visual parameter is a visual parameter in the second brightness mode.

For a specific manner of functional implementation of the third display unit 121, the first statistical unit 122, the first processing unit 123, and the first stop unit 124, reference may be made to operation S202 in the aspect corresponding to FIG. 7. Details are not described herein.

Still referring to FIG. 11, the second display module 12 may further include a fourth display unit 125, a second statistical unit 126, a second processing unit 127, and a second stop unit 128.

The fourth display unit 125 is configured to continuously display the first service message through the second visual parameter when the changed visual parameter reaches the second visual parameter.

The second statistical unit 126 is configured to collect statistics on second display duration during which the first service message is continuously displayed through the second visual parameter.

The second processing unit 127 is configured to perform reverse visual parameter change processing on the first service message starting from the second visual parameter when the second display duration is greater than a second display duration threshold.

The second stop unit 128 is configured to dynamically display the first service message through a reversely changed visual parameter, and stop the reverse visual parameter change processing when the reversely changed visual parameter reaches the first visual parameter, where the second display duration threshold is greater than the first display duration threshold.

The third display unit 121 is further configured to continuously display the first service message through the first visual parameter when the reversely changed visual parameter reaches the first visual parameter.

The first statistical unit 122 is further configured to collect statistics on third display duration during which the first service message is continuously displayed through the first visual parameter.

The third display unit 121 is further configured to eliminate the displayed first service message when the third display duration is greater than a third display duration threshold, where the third display duration threshold is less than the first display duration threshold.

For a specific manner of functional implementation of the fourth display unit 125, the second statistical unit 126, the second processing unit 127, and the second stop unit 128, reference may be made to operation S202 in the aspect corresponding to FIG. 7. Details are not described herein.

Still referring to FIG. 11, the first display module 11 may include a first obtaining unit 115, a first storage unit 116, a second storage unit 117, a second obtaining unit 118, and a fifth display unit 119.

The first obtaining unit 115 is configured to obtain, in response to the first service operation performed by the service object in the first application or in the first subroutine, a service prompt message corresponding to the first service operation through the second application, where a service platform corresponding to the second application is different from a service platform corresponding to the first application.

The first storage unit 116 is configured to determine a program state of the first subroutine in the second application, and store the service prompt message into a cache database corresponding to the second application if the program state of the first subroutine is an unstarted state, where the service prompt message stored in the cache database is configured for being transmitted to a platform basic library corresponding to the second application when the program state of the first subroutine is updated from the unstarted state to a started state.

The second storage unit 117 is configured to store the service prompt message into the platform basic library if the program state of the first subroutine is the started state.

The second obtaining unit 118 is configured to obtain a platform operation policy from the platform basic library, and determine, if the first service message associated with the service prompt message exists in the platform operation policy, that the first service operation meets the control presentation condition.

The fifth display unit 119 is configured to display the first service control in the first subroutine.

For a specific manner of functional implementation of the first obtaining unit 115, the first storage unit 116, the second storage unit 117, the second obtaining unit 118, and the fifth display unit 119, reference may be made to operations S301 to S305 in the aspect corresponding to FIG. 10. Details are not described herein.

Still referring to FIG. 11, the second storage unit 117 may include a first obtaining subunit 1171, a second obtaining subunit 1172, and a message update subunit 1173.

The first obtaining subunit 1171 is configured to obtain a program index of the first subroutine, and obtain a message index table stored in association with the program index from the platform basic library.

The second obtaining subunit 1172 is configured to obtain a message identifier of the service prompt message, and store the message identifier and the service prompt message into the message index table in association if no historical service prompt message having an index relationship with the message identifier exists in the message index table.

The message update subunit 1173 is configured to update, if a historical service prompt message having an index relationship with the message identifier exists in the message index table, the historical service prompt message in the message index table to the service prompt message.

For a specific manner of functional implementation of the first obtaining subunit 1171, the second obtaining subunit 1172, and the message update subunit 1173, reference may be made to operation S303 in the aspect corresponding to FIG. 10. Details are not described herein.

Still referring to FIG. 11, the fifth display unit 119 may include a third obtaining subunit 1191 and a control display subunit 1192.

The third obtaining subunit 1191 is configured to obtain, from the platform operation policy, a presentation manner associated with the service prompt message and a presentation condition associated with the service prompt message.

The control display subunit 1192 is configured to display the first service control in the presentation manner in the first subroutine when the first service control meets the presentation condition.

For a specific manner of functional implementation of the third obtaining subunit 1191 and the control display subunit 1192, reference may be made to operation S305 in the aspect corresponding to FIG. 10. Details are not described herein.

In the aspect of this disclosure, in response to that a first service operation performed by a service object in a first application or a first subroutine embedded in a second application meets a control presentation condition, a terminal device may display a first service control in the first subroutine in the second application, where the first service operation is implemented through a service function provided by the second application; the first service control is provided by the second application; and a service platform corresponding to the first application is the same as a service platform corresponding to the first subroutine. Further, the terminal device may display a first service message in the first service control, where the first service message is provided by the second application, and the first service message is associated with the first service operation. It can be learned from the above that an aspect of this disclosure provides a non-fixed first service control. The first service control is provided by the second application to the first subroutine of the second application. Through the first service control, the second application may deliver the first service message. Therefore, with this application, not only a presentation effect of the first subroutine can be improved, but also display efficiency of the first service message can be improved. Moreover, different service platforms can be prevented from developing service controls respectively, thereby improving service function efficiency of each service platform and reducing development costs.

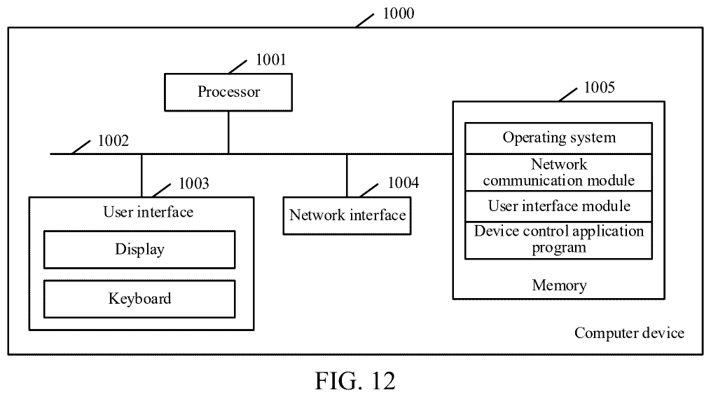

Further, FIG. 12 is a schematic structural diagram of a computer device according to an aspect of this disclosure. As shown in FIG. 12, the computer device 1000 may include at least one processor 1001 (for example, processing circuitry), for example, a central processing unit (CPU), at least one network interface 1004, a user interface 1003, a memory 1005 (for example, a non-transitory computer-readable storage medium), and at least one communication bus 1002. The communications bus 1002 is configured to implement connection and communication between the components. In some aspects, the user interface 1003 may include a display and a keyboard, and the network interface 1004 may include a standard wired interface and a standard wireless interface (for example, a Wi-Fi interface). The memory 1005 may be a high-speed random access memory (RAM), or may be a non-volatile memory, such as at least one magnetic disk memory. In some aspects, the memory 1005 may alternatively be at least one storage apparatus away from the processor 1001. As shown in FIG. 12, the memory 1005 used as a computer storage medium may include an operating system, a network communication module, a user interface module, and a device control application program.

In the computer device 1000 shown in FIG. 12, the network interface 1004 may provide a network communication function. The user interface 1003 is mainly configured to provide an input interface for a user. The processor 1001 may be configured to invoke the device control application program stored in the memory 1005 to implement the following:

in response to that a first service operation performed by a service object in a first application or a first subroutine embedded in a second application meets a control presentation condition, a first service control is displayed in the first subroutine in the second application, where the first service operation is implemented through a service function provided by the second application; the first service control is provided by the second application; the first subroutine is a subroutine corresponding to the first application, a service platform corresponding to the first application is the same as a service platform corresponding to the first subroutine, and the service platform corresponding to the first application is different from a service platform corresponding to the second application; and

a first service message is displayed in the first service control, where the first service message is provided by the second application, and the first service message is associated with the first service operation.

The computer device 1000 described in the aspect of this disclosure can execute the descriptions of the data processing method or apparatus in the foregoing aspects. Details are not described herein. In addition, the descriptions of the beneficial effects of the same method are not repeated herein.

An aspect of this disclosure further provides a computer-readable storage medium, such as a non-transitory computer-readable storage medium. The computer-readable storage medium has a computer program stored therein. After being executed by a processor, the computer program implements the descriptions of the data processing method or apparatus in the foregoing aspects. Details are not described herein. In addition, the descriptions of the beneficial effects of the same method are not repeated herein.

The foregoing computer-readable storage medium may be the data processing apparatus provided in any one of the foregoing aspects or an internal storage unit of the foregoing computer device, such as a hard disk or an internal memory of the computer device. The computer-readable storage medium may alternatively be an external storage device of the computer device, for example, a plug-in hard disk drive, a smart media card (SMC), a secure digital (SD) card, or a flash card equipped on the computer device. Further, the computer-readable storage medium may alternatively include both the internal storage unit and the external storage device of the computer device. The computer-readable storage medium is configured to store the computer program and other programs and data that are required by the computer device. The computer-readable storage medium may be further configured to temporarily store data that has been outputted or is to be outputted.

An aspect of this disclosure further provides a computer program product, including a computer program. The computer program is stored in a computer-readable storage medium. A processor of a computer device reads the computer program from the computer-readable storage medium. The processor executes the computer program, to cause the computer device to execute the descriptions of the data processing method or apparatus in the foregoing aspects. Details are not described herein. In addition, the descriptions of the beneficial effects of the same method are not repeated herein.

The terms “first”, “second”, and the like in the specification, the claims, and the accompanying drawings according to the aspects of this disclosure are intended to distinguish between different objects, instead of describing a specific sequence. In addition, the terms “include” and any variation thereof are intended to cover a non-exclusive inclusion. For example, a process, method, apparatus, product, or device that includes a series of operations or modules is not limited to the listed operations or modules, but further includes operations or modules not listed, or further includes other operations or units inherent to the process, method, apparatus, product, or device.

A person of ordinary skill in the art may realize that, units and algorithm operations of each example described in combination with the disclosed aspects herein can be implemented by electronic hardware, computer software, or a combination thereof. To describe the interchangeability between the hardware and the software, compositions and operations of each example have been described according to functions in the foregoing descriptions. Whether the functions are executed in a manner of hardware or software depends on specific applications and design constraint conditions of the technical solutions. A person skilled in the art may use different methods to implement the described functions for each specific application, but such implementation is not to be considered beyond the scope of this disclosure.

What is disclosed above is merely example aspects of this disclosure, and certainly is not intended to limit the scope of the claims of this disclosure. Therefore, equivalent variations made in accordance with the claims of this disclosure shall fall within the scope of this disclosure.

The foregoing descriptions are merely example aspects of this disclosure, but are not intended to limit this disclosure. Any modification, equivalent replacement, improvement, and the like made without the principle of this disclosure shall fall within the scope of this disclosure.

What is claimed is:

1. A data processing method, comprising:
outputting for display a first service control element in a first subprogram in a second application based on a determination that a first service operation initiated by a user satisfies a display condition,
the first service operation being initiated in a first application or in the first subprogram embedded in the second application,
the first service operation being executed through a service function provided by the second application,
the first service control element being provided by the second application,
the first subprogram corresponding to the first application, and
a service platform corresponding to the first application being different from a service platform corresponding to the second application; and
outputting for display a first service message in the first service control element, the first service message being provided by the second application and being associated with the first service operation.

2. The method according to claim 1, further comprising:
outputting for display a service page provided by the second application based on a trigger operation performed on the first service control element, the service page enabling the user to perform a second service operation associated with the first service operation.

3. The method according to claim 2, further comprising:
obtaining input information based on an input operation performed on the service page;
determining the input information as a second service message, the second application transmitting the second service message to the first application; and
returning from the service page to the display of the first subprogram based on a trigger operation performed on a return control element in the service page, the first service control element being removed from output for display in the first subprogram.

4. The method according to claim 1, further comprising:
outputting for display the first service control element in a second subprogram in the second application based on the user performing the first service operation in a third application or in the second subprogram embedded in the second application, wherein
the second subprogram corresponds to the third application,
a service platform corresponding to the third application is different from the service platform corresponding to the second application, and
the service platform corresponding to the third application is different from the service platform corresponding to the first application.

5. The method according to claim 1, further comprising:
monitoring a continuous display duration of the first service control element; and
removing the output for display of the first service control element when the continuous display duration equals a total display duration threshold.

6. The method according to claim 5, wherein the outputting for display the first service control element comprises:
outputting for display the first service control element in the first subprogram in the second application at a first moment when the first service operation satisfies the display condition; and
the method further comprises:
responding at a second moment to a third service operation performed by the user in the first application or in the first subprogram;
determining a time difference between the second moment and the first moment when the third service operation satisfies the display condition, the third service operation being executed through the service function provided by the second application; and
when the time difference is less than the total display duration threshold, continuously outputting for display the first service control element in the first subprogram;
when the time difference is greater than or equal to the total display duration threshold,
updating the display of the first service control element to a second service control element in the first subprogram, and
outputting for display a third service message in the second service control element, the second service control element being provided by the second application and the third service message being provided by the second application and being associated with the third service operation.

7. The method according to claim 5, wherein the outputting for display the first service control element comprises:
outputting for display the first service control element on a current page of the first subprogram at a third moment when the first service operation satisfies the display condition; and
the method further comprises:
updating the current page to a current updated page at a fourth moment based on a page update operation on the current page, the fourth moment being later than the third moment; and
maintaining output for display of the first service control element on the current updated page when a time difference between the fourth moment and the third moment is less than the total display duration threshold.

8. The method according to claim 1, wherein
the outputting for display the first service control element comprises:
determining a first brightness mode of the second application, and outputting for display the first service control element in the first brightness mode in the first subprogram; and
the outputting for display the first service message comprises:
outputting for display the first service message in a second brightness mode in the first service control element, the second brightness mode being different from the first brightness mode.

9. The method according to claim 8, wherein the outputting for display the first service message in the second brightness mode comprises:
continuously outputting for display the first service message according to a first visual parameter, the first visual parameter corresponding to the first brightness mode;
monitoring a first display duration during which the first service message is continuously output for display using the first visual parameter;
performing visual parameter change processing on the first service message starting from the first visual parameter when the first display duration exceeds a first display duration threshold; and
dynamically outputting for display the first service message according to a changed visual parameter until the changed visual parameter reaches a second visual parameter.

10. The method according to claim 9, wherein the outputting for display the first service message in the second brightness mode comprises:
continuously outputting for display the first service message according to the second visual parameter when the changed visual parameter reaches the second visual parameter;
monitoring a second display duration during which the first service message is continuously output for display using the second visual parameter;
performing reverse visual parameter change processing on the first service message starting from the second visual parameter when the second display duration exceeds a second display duration threshold;
dynamically outputting for display the first service message according to a reversely changed visual parameter until the reversely changed visual parameter reaches the first visual parameter;
continuously outputting for display the first service message according to the first visual parameter when the reversely changed visual parameter reaches the first visual parameter;
monitoring a third display duration during which the first service message is continuously output for display using the first visual parameter; and
removing the output for display of the first service message when the third display duration exceeds a third display duration threshold, the third display duration threshold being less than the first display duration threshold.

11. The method according to claim 1, wherein the outputting for display the first service control element comprises:
obtaining a service prompt message corresponding to the first service operation through the second application based on the user performing the first service operation in the first application or in the first subprogram;
determining a program state of the first subprogram in the second application;
storing the service prompt message in a cache database corresponding to the second application when the program state of the first subprogram is an unstarted state, the service prompt message stored in the cache database being transmitted to a platform base library corresponding to the second application when the program state changes from the unstarted state to a started state;
storing the service prompt message in the platform base library when the program state of the first subprogram is the started state;
obtaining a platform operation policy from the platform base library;
determining that the first service operation satisfies the display condition when the platform operation policy includes the first service message associated with the service prompt message; and
outputting for display the first service control element in the first subprogram.

12. The method according to claim 11, wherein the storing the service prompt message in the platform base library comprises:
obtaining a program index of the first subprogram;
obtaining a message index table stored in association with the program index from the platform base library;
obtaining a message identifier of the service prompt message;
when no historical service prompt message having an index relationship with the message identifier exists in the message index table, storing the message identifier and the service prompt message in association in the message index table; and
when a historical service prompt message having an index relationship with the message identifier exists in the message index table, updating the historical service prompt message in the message index table to the service prompt message.

13. The method according to claim 11, wherein the outputting for display the first service control element in the first subprogram comprises:
obtaining a presentation manner and a presentation condition associated with the service prompt message from the platform operation policy; and
outputting for display the first service control element in the presentation manner in the first subprogram when the first service control element satisfies the presentation condition.

14. A data processing apparatus, comprising:
processing circuitry configured to:
output for display a first service control element in a first subprogram in a second application based on a determination that a first service operation initiated by a user satisfies a display condition,
the first service operation being initiated in a first application or in the first subprogram embedded in the second application,
the first service operation being executed through a service function provided by the second application,
the first service control element being provided by the second application,
the first subprogram corresponding to the first application, and
a service platform corresponding to the first application being different from a service platform corresponding to the second application; and
output for display a first service message in the first service control element, the first service message being provided by the second application and being associated with the first service operation.

15. The apparatus according to claim 14, wherein the processing circuitry is configured to:
output for display a service page provided by the second application based on a trigger operation performed on the first service control element, the service page enabling the user to perform a second service operation associated with the first service operation.

16. The apparatus according to claim 15, wherein the processing circuitry is configured to:
obtain input information based on an input operation performed on the service page;
determine the input information as a second service message, the second application transmitting the second service message to the first application; and
return from the service page to the display of the first subprogram based on a trigger operation performed on a return control element in the service page, the first service control element being removed from output for display in the first subprogram.

17. The apparatus according to claim 14, wherein the processing circuitry is configured to:
output for display the first service control element in a second subprogram in the second application based on the user performing the first service operation in a third application or in the second subprogram embedded in the second application, wherein
the second subprogram corresponds to the third application,
a service platform corresponding to the third application is different from the service platform corresponding to the second application, and
the service platform corresponding to the third application is different from the service platform corresponding to the first application.

18. The apparatus according to claim 14, wherein the processing circuitry is configured to:
monitor a continuous display duration of the first service control element; and
remove the output for display of the first service control element when the continuous display duration equals a total display duration threshold.

19. The apparatus according to claim 18, wherein the processing circuitry is configured to:
output for display the first service control element in the first subprogram in the second application at a first moment when the first service operation satisfies the display condition; and
the processing circuitry is further configured to:
respond at a second moment to a third service operation performed by the user in the first application or in the first subprogram;
determine a time difference between the second moment and the first moment when the third service operation satisfies the display condition, the third service operation being executed through the service function provided by the second application; and
when the time difference is less than the total display duration threshold, continuously output for display the first service control element in the first subprogram;
when the time difference is greater than or equal to the total display duration threshold,
update the display of the first service control element to a second service control element in the first subprogram, and
output for display a third service message in the second service control element, the second service control element being provided by the second application and the third service message being provided by the second application and being associated with the third service operation.

20. A non-transitory computer-readable storage medium storing instructions which, when executed by a processor, cause the processor to perform:
outputting for display a first service control element in a first subprogram in a second application based on a determination that a first service operation initiated by a user satisfies a display condition,
the first service operation being initiated in a first application or in the first subprogram embedded in the second application,
the first service operation being executed through a service function provided by the second application,
the first service control element being provided by the second application,
the first subprogram corresponding to the first application, and
a service platform corresponding to the first application being different from a service platform corresponding to the second application; and
outputting for display a first service message in the first service control element, the first service message being provided by the second application and being associated with the first service operation.
